(19) United States
(12) Patent Application Publication
(10) Pub. No.: US 2017/0259243 A1
(43) Pub. Date: Sep. 14, 2017

(54) METAL OXIDE COATED DIATOMITE AGGREGATE AND USE THEREOF AS ADSORBENT AND FERTILIZER

(71) Applicant: University of Copenhagen, Copenhagen K (DK)

(72) Inventors: Gry Lyngsie, Copenhagen V (DK); Charlotte Kjærgaard, Rødkærsbro (DK); Han Christian Bruun Hansen, Lund (SE)

(21) Appl. No.: 15/511,967

(22) PCT Filed: Sep. 17, 2015
(86) PCT No.: PCT/DK2015/050280

§ 371 Date: Mar. 16, 2017

(30) Foreign Application Priority Data
Sep. 17, 2014 (DK) PA 2014 70572

(51) Int. Cl. B01J 20/14; B01J 20/06; B01J 20/08; C05B 17/00; B01J 20/12; B01J 20/30; B01J 20/32; C02F 1/28; B01J 20/28

(52) U.S. Cl. CPC B01J 20/14; C02F 1/288; C02F 1/281; B01J 20/06; B01J 20/08; B01J 20/2803; B01J 20/12; B01J 20/28085; B01J 20/28059; B01J 20/3078; B01J 20/3204; B01J 20/3225; B01J 20/3289; B01J 20/3234; B01J 20/3293; C05B 17/00; C02F 2101/103

(57) ABSTRACT

The present invention relates to a calcined diatomite aggregate coated with metal oxides, more specifically to a diatomite aggregate having a diameter larger than 2 mm.

### FIELD OF INVENTION

The present invention relates to diatomite aggregate coated with metal oxides, more specifically to a diatomite aggregate having a diameter larger than 2 mm, yielding several advantages such as high hydraulic conductivity and mechanical stability when used as packing material in a column filter and high sorbent efficiency. The present invention relates in particular to a column filter, where the coated diatomite aggregates are used as a filter material to remove phosphate from agricultural drainage water or other high volume waters.

### BACKGROUND OF INVENTION

Porous media are used as filters that physically or chemically retain nutrients and other pollutants present in wastewater from different sources. Water treatment technologies that use porous media are currently used in different contexts and both for urban runoff and for agricultural drainage water. One example is in form of a filter bed placed at the end-of-pipe in connection with a small-scale constructed wetland. Another example of use of porous media is in a flow-through filter structure in ditches. Thirdly, porous media are also used as a reactive material located as a “wrapping” around a drainage pipe.

These treatment systems are all challenged by receiving high volumes of water resulting in high hydraulic loads. In addition, the loads have extremely stochastic behavior (events of high and low water discharge), and furthermore with great variation of concentrations of nutrients and other pollutants. Systems targeting agricultural drainage water are further challenged by the relative low concentration of nutrients compared to waste water.

The common denominator for these different approaches for water treatment is that the porous medium must contain or consist of a removing agent, i.e. a filter material or a sorbent, in order to efficiently remove the pollutant from the aqueous phase.

There are two properties that such a filter material must fulfill: a) it must have sufficient hydraulic conductivity when packed in a filter column, and b) it must have strong retention efficiency to meet the desired quality of the discharged water.

The hydro-physical properties that can affect the hydraulic conductivity are; aggregate size, aggregate size distribution, porosity, pore size distribution, aggregate shape and aggregate stability. The general rule of thumb is that the hydraulic conductivity is positively correlated with medium aggregate size (D₅₀). The higher the hydraulic conductivity of the filter material, the higher the flux of water can be passed through the filter material, and hence, the higher volumes of wastewater that can be treated. The chemical properties affecting a filter material's phosphate removal efficiency in terms of bonding strength, bonding capacity and irreversibility, are closely related to the content of various aluminium, calcium, iron and magnesium (hydr)oxides and carbonates. In addition to the elemental composition and physico-chemical properties of the filter material, the specific surface area (SSA) of the aggregate is also important as sorption normally increases at increasing SSA which is inversely related to aggregate size.

In typical water treatment technologies, small aggregates (with large SSA) are used to achieve high treatment efficiency, while large aggregates (with low SSA) are used to achieve high hydraulic conductivities. A problem is how to obtain a filter material that combines high hydraulic conductivity with high treatment efficiency.

A common filter material is commercially available iron oxides formulated as small particles and which is efficient for phosphate removal from a solution, even at low phosphate solution concentrations, short contact times and in presence of competitive ions. However, a problem with such filter material is that the size of the iron oxide particles are typically in the micrometer range, and hence results in filter materials with low hydraulic conductivities. To overcome this problem, another filter material may be used, having a larger aggregate size. A specific example of such a material may be a diatomite aggregate. However, although relatively large diatomite aggregates may exist, they are typically less than 0.5 mm in diameter, and if larger, they are typically mechanically unstable and may not exist in that size for a long time. Thus, unless stabilized they may separate into smaller aggregates, which are unsuitable as a filter material, especially if high hydraulic conductivity is required in such a filter.

### SUMMARY OF INVENTION

An objective of the present invention is thus to provide a filter material that has both high hydraulic conductivity when used in a column filter and is an efficient sorbent, but also that the material is mechanically stable. Accordingly, the present invention relates to a calcined diatomite aggregate having a diameter of at least 2 mm, wherein said aggregate is coated with a metal oxide. Further, the present invention relates to the use of diatomite aggregates for purification of an aqueous fluid. Even further, the present invention relates to a filter, comprising a plurality of diatomite aggregates. The present invention also relates to a process of treating a diatomite aggregate, comprising the steps of: soaking said diatomite aggregates in a metal solution; drying the soaked diatomite aggregates; neutralizing the dried and soaked diatomite aggregates; and repeating the procedure on the same diatomite aggregates at least two times. Even more further, the present invention relates to a process for purifying a fluid, comprising the steps of: providing a filter as described, and passing said fluid through said filter such that said fluid comprising impurities are adsorbed on a surface of said diatomite aggregates, wherein said surface is an external surface of said diatomite aggregates and/or on said internal pores of said diatomite aggregates. Finally, the present invention relates to a fertilizer product produced by the method as just described.

An effect of the present invention is that the material combines the ideal physical properties of calcined diatomite aggregates, i.e. large and stable aggregates with a high internal porosity and hence high SSA. The present invention thus provides a filter material that has both the physical and chemical properties needed for a porous filter material to be used in a flow-through setup. The filter material may be installed in a filter at the end of drainage pipes to remove phosphate before the drainage water enters streams and lakes, where it can cause eutrophication, algal blooming and fish kills if not cleaned for phosphate.

Due to its presence of metal oxide, the filter material may be valuable in applications where for example phosphate and/or arsenate should be retained from high volumes of water that has to be passed quickly through a filter (short retention times) and also should be applicable for waters with low and variable phosphate and/or arsenate concentrations. The filter material may be intended for use in filter units for agricultural drainage water—or any other less polluted waters, e.g. lake water, rain water from urban runoff, certain types of industrial water or flooding water. An effect of the filter medium is that filters filled with this filter material can take high fluxes of water, sorb phosphate and/or arsenate quickly which is required due to low retention times, and can sorb phosphate at the rather low solution concentrations which is normally present in drainage waters.

A further effect of the invention is that the filter material with its load of phosphorus can be used as a fertilizer, and hence the phosphorus can be recycled. Diatomite is a natural non-toxic earthy material and will be easily incorporated into the soil to act as a slow-release fertilizer. Alternatively, the phosphate bound to the filter material may be extracted and the filter material regenerated.

### DESCRIPTION OF DRAWINGS

FIG. 1. Examples of phosphate sorption isotherms for a) uncoated calcined CDE, b) single Al oxide coated calcined CDE using 1.2 M PAX-15, and c) Triple Fe oxide coated calcined CDE (three successive coatings with 0.2 M PIX-111) at different contact times.

FIG. 2. Examples of phosphate sorption isotherms for calcined CDE's coated with i) triple coating of Fe oxide using 0.2 M PIX-111, ii) single coating of Al oxide using 1.2 M PAX-15, iii) double coating of Al oxide using 0.7 M PAX-15, iv) single coating of Al oxide using 0.7 M PIX-111 and v) single coating of Fe oxide using 2 M PIX-111 at exposure times of a) 20 minutes and b) 1 week.

FIG. 3 Examples of Fe/Al content of calcined coated CDE using various concentrations of PIX and PAX solutions and the result of successive coatings of the same material. In particular a) Fe content of PIX-111 coated products with one, two or three successive layers of coating, and b) Al content of PAX-15 coated products with one, two or three successive layers of coating.

FIG. 4. Specific surface area of calcined CDE coated with a) Al oxide, or b) Fe oxide using various coating concentrations and strategies. Error bars show standard deviations of triplicate determinations.

FIG. 5. Images of the aggregate of the present invention, imaged at various magnifications: a) permeable drainage well with a reactive filter to capture sorbates, b) photo of the coated calcined CDE particles, c) microscope image of the surface of the coated calcined CDE and d) SEM image of the aggregate according to the present invention.

FIG. 6. SEM images of the morphology and texture of an example of an aggregate according to the present invention. In particular, a) and b) show SEM images of an aggregate coated with a metal oxide having a coating thickness of less than 1 nm, and c) shows an SEM image of an aggregate, where the aggregate is uncoated.

FIG. 7. Scanning Electron Microscopy—Energy Dispersive X-ray (SEM-EDX) analyses of Fe oxide coated CDE after exposure for a) 12 min, b) 120 min, c) 1200 min and d) 12000 min to a phosphate solution of initially 320 uM. Density of the green dots express the relative concentration of P in transects of the calcined Fe oxide coated CDE particles.

### DETAILED DESCRIPTION OF THE INVENTION

Definitions

The term “approximately” refers to a value which is within 50%, such as within 40%, such as within 30%, such as within 20%, or such as within 10%, since for example a composition of containing an approximately value of a given material may be formed naturally and thus not formed from a perfectly controlled process.

The term ‘pore’ as used herein refers to a structure having dimensions wherein the length is larger than the width.

The term ‘internal pores’ as used herein refers to a structure or a pore within an aggregate.

The term ‘intra pores’ as used herein refers to pores between the aggregates.

The term ‘inter-connected’ as used herein refers to a network of pores on a coating surface. The term relates to interconnected porosity. There are two kinds of porosity—open and closed: Open porosity, also known as interconnected porosity, is the ratio of the volume of void space within the material that is accessible from the exterior to the bulk volume. Closed porosity, also known as internal porosity, is the ratio of the volume of void space within the material that is not accessible from the exterior to the bulk volume. The total porosity of a material is the sum of the open and closed porosity.

The term ‘saturated hydrologic capacity’ as used herein refers to a measure of the volume of water which a saturated aggregate can pass. A saturated aggregate is obtained by saturating the aggregate with water and subject it to a hydraulic overpressure. The pressure can be kept constant (constant-head method), but it is also possible to let the pressure drop as a result of the flow of water through the sample. The K-value of a saturated aggregate represents its average hydraulic conductivity, which depends mainly on the size, shape, and distribution of the pores. It also depends on the temperature and the viscosity and density of the water.

Filter Material

In one embodiment of the present invention, the diatomite aggregate is made of a diatomite-containing material, wherein said diatomite-containing material comprises approximately ⅓ clay and ⅔ diatomite. The diatomite aggregate may be naturally formed and come from naturally occurring formations, such as the Fur formation in Denmark, where the diatomite aggregate naturally consists of approximately ⅓ clay and ⅔ diatomite. The diatomite containing aggregates consist of millions of micrometer-sized particles (amorphous silicate shells from diatomite algae). The composition of the diatomite aggregates from the Fur formation consisting of approximately ⅓ clay and ⅔ diatomite is a unique mixture of clay and diatomite that makes it possible to obtain aggregates larger than 2 mm which may be further stabilized through calcination (so-called calcined diatomaceous earth, CDE). An important property of this CDE is the presence of internal pores consisting of intra pores within the aggregates and internal, or inter pores between the aggregates, the pore diameters ranging from less than 10 micrometer to less than 1 micrometer. After Al/Fe oxide-coating of external and internal surfaces, phosphate sorption on external sites will be fast but over time (minutes to hours and days) phosphate will diffuse from external to internal (pore) sites preventing phosphate desorption while preserving fast sorption on external sorption sites. Because of this composition and these properties, the present invention is related to a material very much superior to previously proposed filter materials.

In another embodiment of the present invention, the diatomite aggregate further comprising internal pores to allow for diffusion of a liquid. Preferably, the internal pores have an average pore diameter of less than 10 microns, such as less than 9 microns, such as less than 8 microns, such as less than 7 microns, such as less than 6 microns, such as less than 5 microns, such as less than 4 microns, such as less than 3 microns, such as less than 2 microns, or such as less than 1 microns. More preferably, at least a fraction of said internal pores are inter-connected. Even more preferably, the diatomite aggregate further comprising intra pores to allow for diffusion of a liquid. In this way, there may be formed pores within a plurality of diatomite aggregates, i.e. when the aggregates are packed together. In this sense, it may be stated that the aggregate is double porous due to the presence of both inter and intra pores.

All the internal pores share a total surface area with the outside surface of the aggregate. In one embodiment of the present invention, the diatomite aggregate has a specific surface area of greater than 10 m²/g, such as greater than 20 m²/g, such as greater than 30 m²/g, such as greater than 40 m²/g, such as greater than 50 m²/g, such as greater than 60 m²/g, such as greater than 70 m²/g, such as greater than 80 m²/g, such as greater than 90 m²/g, or such as greater than 100 m²/g.

Treatment

In a preferred embodiment of the present invention, the diatomite aggregate is thermally treated, such as by calcination or flux calcination. Preferably, the aggregate is calcined. Alternatively, the aggregate may be flux calcined. Calcination is the process of burning at high temperatures, typically 700-800° C., resulting in CDE. During the calcination the small aggregates sinter together to form big and stable aggregates. Such material consisting of relative big aggregates (larger than 2 mm) may be commercially available. For example, CDE from the Fur formation is calcined at 750° C. at the factory Damolin A/S, Denmark, where they obtain aggregate sizes between 2-4 mm.

In accordance with the present invention, CDE containing aggregates fulfill the requirements for achieving high hydraulic conductivities when used in a column filter. CDE containing aggregates alone shows very poor phosphate and/or arsenate sorption, especially at the concentration ranges found in agricultural drainage waters. Hence, CDE containing aggregates alone do not fulfill the requirement for strong and fast phosphate bonding. For this reason it is an important feature of the present invention, that the diatomite material is coated with a metal oxide.

An effect of the aggregate calcination is that calcination may contribute to obtaining the aggregate with diameter larger than 2 mm according to the present invention. After calcination the aggregates may be fractioned such that they have the same size. In an embodiment of the present invention, aggregates having 2 mm or 4 mm diameter were used.

Another effect of calcinating the aggregate is that the calcination may contribute to stabilizing the aggregate and may make it resistant to disintegration in water. Furthermore, calcination may ensure that the material can be transported and packed into columns without physical disintegration. Un-calcined diatomaceous earth may slake in water.

In a preferred embodiment of the present invention, the aggregate is adapted such that said aggregate is stable in dry conditions for more than 1 minutes, such as for more than 2 minutes, such as for more than 3 minutes, such as for more than 4 minutes, and/or such as for more than 5 minutes.

In another preferred embodiment of the present invention, the aggregate is adapted such that said aggregate is stable in wet conditions for more than 10 minutes, such as for more than 11 minutes, such as for more than 12 minutes, such as for more than 13 minutes, such as for more than 14 minutes, and/or such as for more than 15 minutes.

The aggregate may for example be heat treated such as for example by calcination, thereby adapting the aggregate such that it has its stability as described above. Stability may be determined by repeated treatments in a sieve shaker, for example having amplitude of 1.5 rpm, and mesh size of 2 mm. Two rubber cubes may in addition be added to the sieve shaker. By placing the aggregate and the rubber cubes in the sieve shaker, the mass that passes the sieve may be determined. When half of a given mass has passed the sieve shaker, the time, t½, defines the measure of the aggregates' stability, thus being the amount of time it takes before a given mass of the aggregate is halved. In dry conditions, nothing is done to the aggregate before treatment in the sieve shaker, whereas in wet conditions, the aggregate is soaked in water over night and drained for water in excess prior to treatment in the sieve shaker.

Coating

As previously described, it is a feature of the present invention, that the diatomite-containing material is coated with a metal (hydr)oxide, here termed metal oxide. In one embodiment of the present invention, the metal oxide comprises amorphous iron oxide or aluminium oxide. In another embodiment, iron oxide has formula Fe₂O₃ and aluminium oxide has formula Al₂O₃. The oxide coating is prepared by soaking CDE in an acidic solution of Fe (or Al), e.g. iron(III) chloride or iron(III) sulphate followed by neutralization of the acidity by adding a base solution, e.g. sodium hydroxide, sodium bicarbonate or ammonia (Example 2). The soaking solution may be partly neutralized with NaHCO₃ before the soaking process. The neutralization is performed to reduce the required amount of base to be added to the CDE after soaking, and in order to minimize acid dissolution of Fe oxides already coated onto the CDE. After base neutralization and washing to remove excess salts, the product is dried. One purpose of coating with iron oxide, is that phosphate and/or arsenate can sorb strongly to iron oxides. Thus, several effects are achieved with the iron oxide: a) the filter material may sorb phosphate strongly and fast, and b) the filter material may have slow desorption of phosphate due to phosphate captured within the pores of the aggregates. In combination with inter and intra pores, the filter material may also provide high sorption capacities over time as phosphate initially sorbed to the outer surfaces of the iron-oxide coated CDE may migrate from an outer surface to an inner surface. Overall, the filter material may offer a high hydraulic conductivity, a strong, fast and irreversible phosphate and/or arsenate sorption, and a high capacity to sorb phosphate and/or arsenate.

The CDE aggregates may be coated with thin films of iron oxide (or aluminium oxide) but without clogging the internal pores and without decreasing the SSA. In one embodiment of the present invention, the metal oxide has a coating thickness of more than 1 nm, such as more than 2 nm, such as more than 3 nm, such as more than 5 nm. In a preferred embodiment the metal oxide has a coating thickness of less than 1 nm, such as less than 0.75 nm, such as less than 0.5 nm, or such as less than 0.25 nm. The coating may be performed more than a single time, such as two times, or such as three times, or more times, resulting in multiple coatings of the diatomite aggregates. In other words, the metal oxide may comprise one or more coating layers.

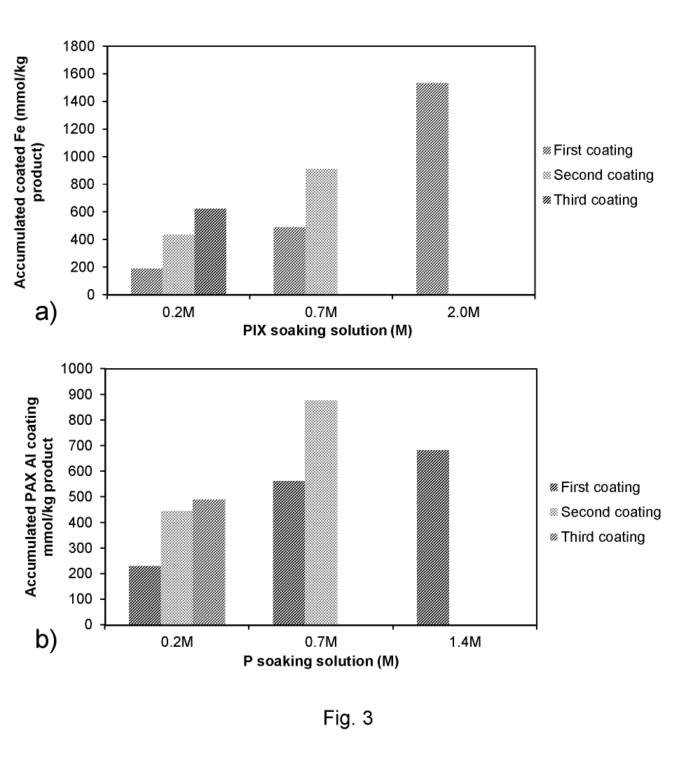

The multiple coated CDE contains significantly more Fe or Al than the single coated CDE and it allows incorporation of high amounts of metals without the need of using high concentrated soaking solutions, as shown in FIG. 3.

According to the present invention related to the aspect of process of treatment, the solution in which the diatomite aggregates are soaked, may be partly neutralized with NaHCO₃.

In one embodiment of the process of treatment, the repeating of the procedure is three times.

Filter

In one embodiment of the present invention, the fluid is a liquid, such as drainage water, more particular agricultural drainage water.

In one embodiment of the present invention, the filter is a column filter. A column filter may be made of the aggregates according to the present invention, and may therefore handle high hydraulic loads and hence treat large volumes of waste water, e.g. phosphate-contaminated drainage water from agricultural fields.

In another embodiment of the present invention, the filter is a filter bed. A filter bed may be a matrix consisting of a porous matrix such as CDE that can be penetrated with water. It may be anything from a hole in the ground filled with material to a cassette in a ditch.

In yet another embodiment of the present invention, the filter is a passive filter. In this context, the filter may not be required to have a pump connected to it. However a pump could be connected to the filter. Preferably, the fluid may simple flow through the filter due to gravity and without being pumped.

In one embodiment of the present invention, the filter has a saturated hydrologic capacity of up to K=200.000 cm/day, such as up to K=175,000 cm/day, such as up to K=150,000 cm/day, such as up to K=135,000 cm/day, or such as up to K=100,000 cm/day. Preferably, the hydrologic capacity is about 135,000 cm/day (Example 1). For comparison, the hydrologic capacity of coarse sand is about 10,000 cm/day.

Process of Filtering

In one embodiment of the present invention, the process is a batch process, similar to a batch sorption experiment. This may be an experiment where filter material (the solid) is exposed to solution containing a known initial concentration of phosphate (the sorbate) and the mixture subsequently agitated to stimulate reaction between the sorbate and the solid with equilibrium obtained when there is no further change in composition (phosphate content) of the aqueous or solid phases. This method does not simulate reactivity under flow conditions.

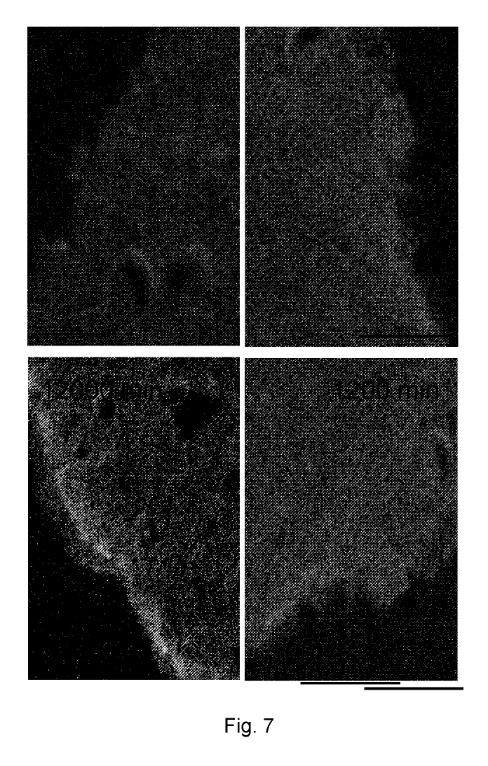

In a preferred embodiment of the present invention, the impurities are ions, in particular sorbate ions, such as anions, oxyanions, especially such as phosphorus ions, such as phosphate ions and/or partly hydrogenated phosphate ions, for example H₂PO₄(−) or for example HPO₄(2−). Alternatively, the impurities may be oxyanions of arsenic such as arsenate ions and/or partly hydrogenated arsenate ions. In one embodiment the anions are contained in agricultural drainage water. In one embodiment the anion is aqueous phosphate ions in drainage water e.g. agricultural drainage water. In one embodiment the phosphate ions binds the surface of the coated CDE and then quickly distribute in the internal pores of the aggregates (see also FIG. 7 and Ex. 9).

The oxide-coated CDE can be used to remove phosphate from drainage water from agricultural fields avoiding eutrophication of recipient open waters. Fe oxide-coated CDE may also be used to clean drainage water polluted with arsenate and chromate from wood impregnation sites.

The phosphate-saturated filter material produced in the process can be used as phosphate fertilizer product on agricultural land. However, the oxide-coated CDE can be used to remove arsenate and chromate from drainage water from wood impregnation sites but after use such material is highly toxic and must be treated as hazardous waste.

### EXAMPLES

### Example 1

### Specific Surface Area and Saturated Hydraulic Conductivity

An aggregate according to the present invention has been exposed to mechanical stresses in wet and dry conditions in order to determine physical properties of the aggregate according to the present invention. Stability has been determined by repeated treatments in a sieve shaker (amplitude 1.5 rpm, mesh size 2 mm) with two rubber cubes added and determining the mass of the material which has passed the sieve. 25 g dry aggregate material was used in each analysis. For the wet aggregate testing the material was soaked in water over night and drained for water in excess prior to analysis. Results appear in Table 1. From Table 1, it can be seen that the saturated hydraulic conductivity is found to be K=135,000 cm/day. From Table 1 it can further be seen that according to the present invention, the specific surface area of the uncoated calcined material is greater than 10 m²/g, such as greater than 20 m²/g, namely 29.9 m²/g.

TABLE 1
Saturated hydraulic load, specific surface area and aggregate stability
(dry and wet). All results are for un-coated CDE having a diameter
of 2-4 mm. Number in bracket is standard deviation.

| SSA outer surface^{§} | m²/g | 3.2-6.3 *10⁻³ |
|---|---|---|
| SSA measured | m²/g | 29.9 (1.9) |
| SSAₒₛ/SSA_{meas.} ^{#} | | 1.59*10⁻⁴ |
| Density of CDE | g/cm³ | 0.475 |
| Kₛₐₜ of CDE ^{‡} | cm/day | 135 000 |
| Fe content | mmol/kg | 596 (4.5) |
| Al content | mmol/kg | 707 (12.5) |
| t½ dry^{†} | min | 3.7 |
| t½ wet^{†} | min | 14.6 |

^{§}SSA outer surface is based on the theoretical calculation of SSA (6/pd).
^{#} The SSAₒₛ/SSA_{meas.} is the ratio between the theoretical outer surfaces vs. the measured SSA. Large SSAₒₛ/SSAₘₑₐₛ indicate that CDE have an intra-porosity and further that the pores are connected.
^{‡} The Kₛₐₜ is the saturated hydraulic conductivity, in comparison Kₛₐₜ for a coarse sand (particle < 2 mm) is 10 000 cm/day.
^{†}The t½ is a measure of the aggregates' stability, and indicates amount of time it takes before half of the aggregate is broken, in comparison the t½ dry for Celite 0.7 min.

### Example 2

### Metal Oxide Coatings

This example shows how an aggregate according to the present invention is being coated with a metal oxide. The present example shows specifically that a diatomite aggregate having a diameter of at least 2 mm, such as at least 2.1 mm, such as at least 2.2 mm, such as at least 2.3 mm, such as at least 2.4 mm, such as at least 2.5 mm, such as at least 2.6 mm, such as at least 2.7 mm, such as at least 2.8 mm, such as at least 2.9 mm, or such as at least 3 mm, wherein said aggregate is coated with a metal oxide. In particular, diatomite aggregates having 2 mm and 4 mm diameter were used. Concentrated Fe(III) and Al(III) salt solutions used for metal oxide coating of diatomaceous earth were obtained from Kemira. For iron oxide coatings the solutions used were PIX-111, PIX-113 and PIX-118. For the aluminium oxide coatings the solutions PAX-15 and PAX XL-100 were used. The obtained stock solutions were diluted to desired Fe/Al concentrations ranging from 0.2 M to 2 M. 50 g of dry CDE is soaked with 60 mL of dilute iron(III) or aluminium salt solutions (Table 2) overnight; the volume of solution is the volume of liquid that can be entirely absorbed by the CDE. The metal salt solution that is used may be partly neutralized with NaHCO₃ before the soaking process. After soaking the material is dried in an oven at 40° C. Next, the material is titrated to approximately pH 7 (not above pH 8) with sodium hydroxide to precipitate iron or aluminium oxides in the material. Subsequently the material is rinsed with water until the washing solution obtains low turbidity, and the material is dried at room temperature.

TABLE 2
The different coating solution characteristics

| | | | | | | PAX |
|---|---|---|---|---|---|---|
| | | PIX 111 | PIX 113 | PIX 118 | PAX 15 | XL100 |
| Solution | | FeCl₃ | Fe₂(SO₄) | FeClSO₄ | Poly | Poly |
| | | | | | AlCl₃ | AlCl₃ |
| Fe content | mM | 2010 | 1940 | 1960 | 0.6 | 0.6 |
| Al content | mM | 8.8 | 2.1 | 1.5 | 3630 | 4190 |
| pH | | −0.7 | 0.1 | −0.2 | 0.5 | 0.9 |
| Acid equival. | M | 10.6 | 9.09 | 8.65 | 7.95 | * |
| Coating | 0.2 | x | x | x | x | x |
| solutions^{‡} (M) | 0.5 | x | x | x | x | x |
| | 0.7 | x | | | x | |
| | 1.2 | x | | | x | |
| | 2.0 | x | | | x | x |

^{‡}Not all analyses have been carried out on every coating.
*PAX XL100 does not contain any excess acid.
The symbol “x” means that the experiment was performed.

### Example 3

### Process of Filtering of Phosphate

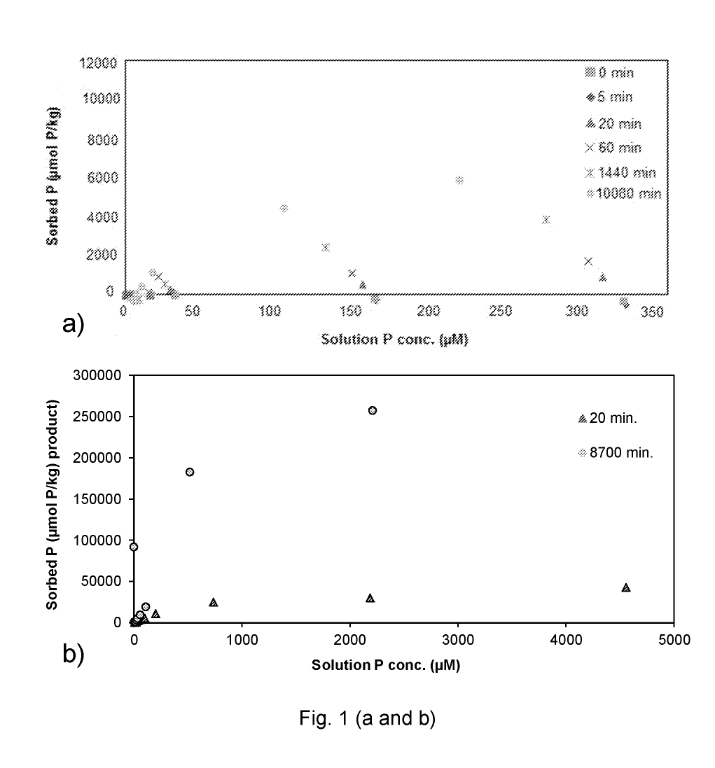

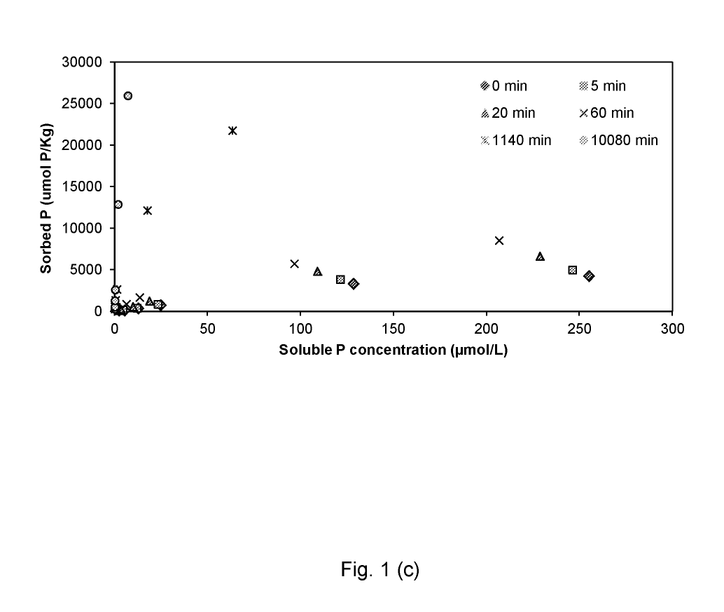

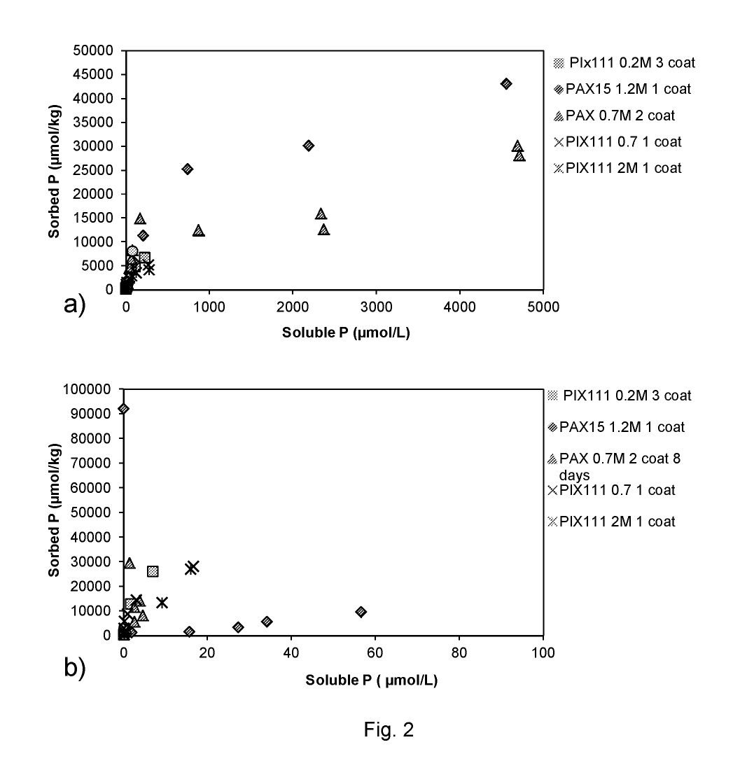

The present example shows that phosphate can be adsorbed by the aggregate according to the present invention. The phosphate sorption properties of the material have been characterized by determination of phosphate sorption isotherms made with initial phosphate concentrations between 0 and 320 μM, initial solid:solution ratios of 1:100 and sub-samples taken at different exposure times (0 min up to 7 days). Phosphate added was in the form of KH₂PO₄, and pH of the mixtures were initially adjusted to pH=7 using 0.1M NaOH. At fixed exposure times 5 mL of solution was sampled and filtered through a 0.2 μm membrane filter before determination of phosphate. Phosphate in the filtrates was determined by the molybdenum blue method using flow injection analysis on a FIAstar 5000 instrument. Sorbed phosphate (μmol/kg) was calculated as the difference between the phosphate concentrations before and after shaking with the filter materials multiplied with the volume of solution and divided by the mass of the CDE used. Selected results appear from FIG. 1. The present example has shown that a process for purifying a fluid, can be comprised by the steps of: providing a filter according to the present invention, and passing said fluid through said filter such that said fluid comprising impurities are adsorbed on a surface of said diatomite aggregates, wherein said surface is an external surface of said diatomite aggregates and/or on said internal pores of said diatomite aggregates.

### Example 4

### Coating Demonstration

The present example shows that an aggregate according to the present invention has been demonstrated. 0.25 g of the metal oxide coated CDE was crushed using an agate mortar, and the crushed material added to 25 mL of 4M HCl and heated in a water bath for 30 min. Al and Fe content in extracts were determined by atomic absorption spectroscopy (AAS) using a Perkin Elmer 3300. The amended Al and Fe contents are shown in FIG. 3. The different coating solutions used influenced the Fe and Al content (mmol/kg) of the aggregates compared to the Fe and Al content of un-coated CDE. The un-coated CDE containes 596 (std. 4.5) and 707 mmol/kg of Fe and Al, respectively.

### Example 5

### Multiple Coating

The present example shows that multiple layers of iron oxide can be coated onto CDE. The CDE material is soaked in a 0.2 M PIX-111 solution, dried and then neutralized with NaOH. After drying this coating procedure is repeated twice resulting in a material with three successive coatings. FIG. 3 shows that almost the same amount of Fe is deposited for each coating resulting in a total amended Fe content of the material of 600 mmol/g. Thus multiple coating is a strategy to add more Fe to the material than can be deposited in a single coating. The maximum amount of Fe that can be deposited from a PIX solution by use of an undiluted solution resulting in a final added Fe content of the material of approx. 1650 mmol Fe per kg product.

### Example 6

### Specific Surface Area (SSA)

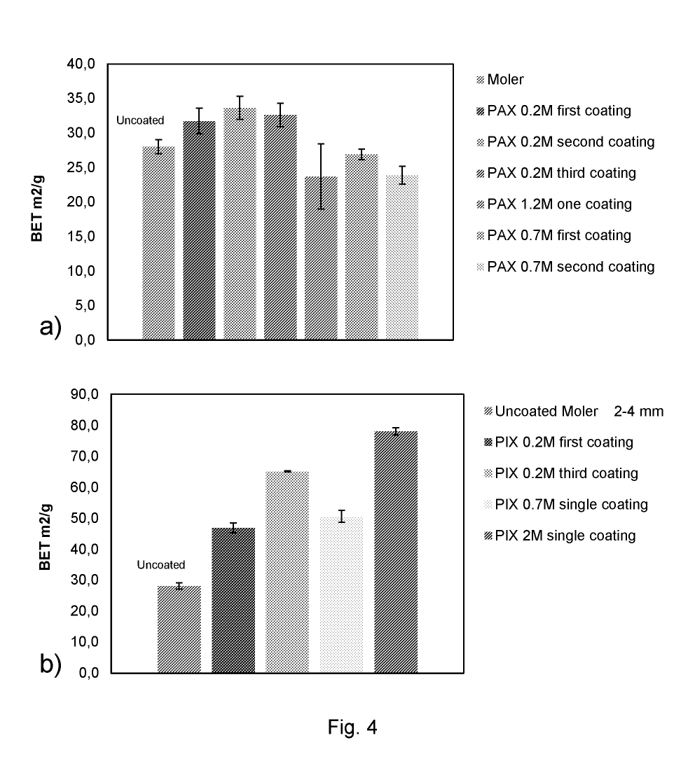

The present example shows that an aggregate according to the present example has a specific surface area according to the present invention. However, the SSA depends on the coating of the aggregate according to the present invention. The SSA of the different coated and uncoated CDE was determined by applying the BET equation to N₂ adsorption data obtained by means of a Micromeritic Gemini VII 2390a instrument. The materials were degassed at 30° C. overnight. Results appear from FIG. 4. It can be seen that the different coatings influence the SSA (m²/g) compared to SSA of untreated CDE. The example shows that an aggregate with an SSA: 29.9 mm²/g can have a standard deviation of 1.9 m²/g.

### Example 7

### Aggregate and Filter

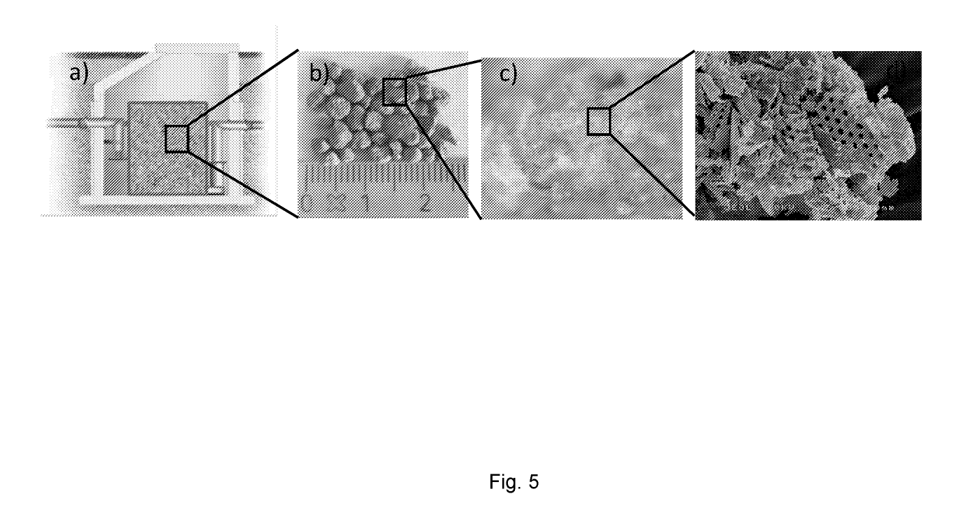

FIG. 5a) shows a permeable drainage well with a reactive filter to capture sorbates, FIG. 5b) shows a photo of the coated calcined CDE particles, FIG. 5c) is a scanning electron microscope (SEM) image of the surface of the coated CDE—the surface appears heterogeneous. FIG. 5d) shows a SEM image of the aggregate according to the present invention. It is clear that the aggregate consists of clay minerals and diatomite shells.

### Example 8

### Aggregate and Pores

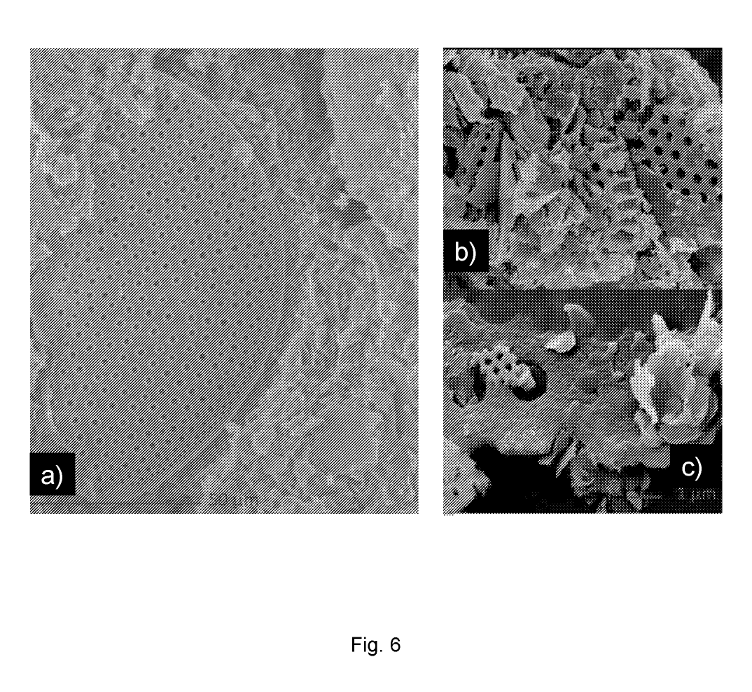

FIG. 6a)-FIG. 6c) show SEM images of the morphology and texture of an example of an aggregate according to the present invention. FIG. 6a)-c) show examples of the morphology of a diatomite aggregate according to the present invention, where different pore sizes within the diatomite aggregate are present. In this example, the aggregate is a diatomite-containing aggregate comprising approximately ⅓ clay and ⅔ diatomite. FIG. 6b)-FIG. 6c) show clearly diatomite and clay minerals. The aggregate is thermally treated, specifically, the aggregate is calcined. From this example, it can be seen that the diatomite aggregate comprises internal pores to allow for diffusion of a liquid into the aggregate. It can further be seen that the internal pores have an average pore diameter of less than 10 microns, such as less than 9 microns, such as less than 8 microns, such as less than 7 microns, such as less than 6 microns, such as less than 5 microns, such as less than 4 microns, such as less than 3 microns, such as less than 2 microns, or such as less than 1 microns. Even further, it can be seen that at least a fraction of said internal pores are inter-connected. FIG. 6a)-b) show SEM images of an aggregate, where the aggregate is coated with a metal oxide having a coating thickness of less than 1 nm, such as less than 0.75 nm, such as less than 0.5 nm, or such as less than 0.25 nm. For comparison, FIG. 6c) shows an SEM image of an aggregate, where the aggregate is uncoated. By comparing FIG. 6a)-b) with FIG. 6c), it can be observed, that no difference in texture or morphology can be detected between coated and un-coated aggregates. This correspond well with the coating thickness being less than 10 microns, such as less than 9 microns, such as less than 8 microns, such as less than 7 microns, such as less than 6 microns, such as less than 5 microns, such as less than 4 microns, such as less than 3 microns, such as less than 2 microns, or such as less than 1 microns.

### Example 9

### Phosphate Uptake into CDE Aggregate Interior

The postulated phosphate uptake in the coated calcined CDE particle interior appears from Scanning Electron Microscopy Energy Dispersive X-ray analysis (SEM-EDX). Iron oxide coated CDE particles were immersed in a phosphate solution of 320 uM at a solid:solution ratio of 1:50. Six particles were removed from the solution after exposure for 0.2, 2, 20 and 200 h. After embedding the particles in a resin, transecting the particles, polishing and coating with a thin layer of carbon to prevent charging during imaging the particles were analysed by SEM-EDX. Results are shown in FIG. 7. The figure shows that phosphorus is located throughout the particle even after 12 min. Hence, phosphorus in the solution in which CDE particles were immersed, has quickly transported into interior parts of the particle demonstrating connectivity between outer and inner parts of the particle and that the interior parts of the particles contain Fe oxide coatings that can sorb phosphate.

### Example 10

### Purification of a Fluid

As an example, purification of a fluid is obtained by passing fluid, such as water, through a filter according to the present invention. The filter comprises diatomite aggregates having an external surface and an inner surface on the internal pores such that the impurities, for example ions, such as for example, phosphorus ions or phosphate ions or arsenate ions, in the water are adsorbed on the diatomite aggregates, in particular on the external surface and the inner surface. After passing water through the filter, the water contains fewer phosphorus, phosphate or arsenate ions and is thus purified.

### Example11

### A Fertilizer Product

As an example, a fertilizer product is obtained by passing water through a filter according to the present invention. The filter comprises diatomite aggregates having an external surface and an inner surface on the internal pores such that the impurities, for example ions, such as for example, phosphorus ions or phosphate ions, in the water are adsorbed on the diatomite aggregates, in particular on the external surface and the inner surface. After passing water through the filter, the aggregates with accumulated phosphorus are collected and can for example be spread on a field as a fertilizer.

1-38. (canceled)

39. A diatomite aggregate comprising a diameter of at least 2 mm, an aggregate surface with internal pores defined on the aggregate surface, wherein at least a fraction of the internal pores are inter-connected; and
a metal oxide coating the aggregate.

40. The diatomite aggregate according to claim 39, the aggregate further comprising intra pores within the aggregate, at least a fraction of the intra-pores being connected.

41. The diatomite aggregate according to claim 39, wherein the aggregate is a diatomite-containing aggregate comprising approximately ⅓ clay and ⅔ diatomite.

42. The diatomite aggregate according to claim 39, wherein the internal pores have an average pore diameter of less than 10 microns.

43. The diatomite aggregate according to claim 39, wherein the aggregate has a specific surface area selected greater than 10 mm²/g.

44. The diatomite aggregate according to claim 39, wherein said aggregate is thermally treated.

45. The diatomite aggregate according to claim 39, wherein the aggregate is calcined.

46. The diatomite aggregate according to claim 39, wherein the metal oxide comprises Fe₂O₃ and/or Al₂O₃, or amorphous Fe₂O₃ and/or Al₂O₃.

47. The diatomite aggregate according to claim 39, wherein the metal oxide has a coating thickness of more than 1 nm.

48. The diatomite aggregate according to claim 39, wherein the metal oxide has a coating thickness of less than 1 nm.

49. The diatomite aggregate according to claim 39, wherein the metal oxide coating comprises one or more coating layers.

50. The diatomite aggregate according to claim 39, wherein the aggregate is heat treated such that the aggregate is stable in dry conditions for more than 1 minute.

51. The diatomite aggregate according to claim 39, wherein the aggregate is heat treated such that the aggregate is stable in wet conditions for more than 10 minutes.

52. A process of manufacturing a diatomite aggregate according to claim 39, comprising the steps of:
soaking a diatomite aggregate in a metal solution;
drying the soaked diatomite aggregate;
neutralizing the dried and soaked diatomite aggregate; and
repeating the procedure on the same diatomite aggregate at least two times.

53. The process according to claim 52, wherein the solution is partly neutralized with NaHCO₃.

54. The process according to claim 52, wherein the repeating the procedure is three times.

55. A process for purifying a fluid, comprising the steps of:
providing a filter comprising a plurality of diatomite aggregates according to claim 39; and
passing the fluid through the filter such that the fluid comprising impurities are adsorbed on a surface of the diatomite aggregates, wherein the surface is an external surface of the diatomite aggregates and/or on the internal pores of the diatomite aggregates.

56. The process according to claim 55, wherein the impurities are ions.

57. The process according to claim 56, wherein the ions are phosphorus ions or phosphate ions or partly hydrogenated phosphate ions.

58. The process according to claim 56, wherein the ions are arsenate ions or partly hydrogenated arsenate ions.
